(19) United States
(12) Patent Application Publication
(10) Pub. No.: US 2015/0040021 A1
(43) Pub. Date: Feb. 5, 2015

(54) METHOD FOR LOADING ADDITIONAL CONTENT ACCORDING TO CHARACTERISTIC OF USER'S CONTENT CONSUMPTION IN TABLE VIEW CONTROLLER ENVIROMENT, AND SYSTEM THEREFOR

(71) Applicant: Korea Advanced Institute of Science and Technology, Daejeon (KR)

(72) Inventors: Jin Hong Yang, Daejeon (KR); Hyo Jin Park, Daejeon (KR); Jun Kyun Choi, Daejeon (KR)

(73) Assignee: Korea Advanced Institute of Science and Technology, Daejeon (KR)

(21) Appl. No.: 14/383,516

(22) PCT Filed: Dec. 6, 2012
(86) PCT No.: PCT/KR2012/010523

§ 371 Date: Sep. 5, 2014

(30) Foreign Application Priority Data
Mar. 13, 2012 (KR) 10-2012-0025652

(51) Int. Cl. G06F 3/0484; G06F 3/0488; G06F 3/0482

(52) U.S. Cl. CPC G06F 3/04842; G06F 3/0482; G06F 3/0488
USPC 715/739

(57) ABSTRACT

A method and a system for loading additional content based on a user's content consumption propensity in a table view controller environment are disclosed. The method for loading additional content includes a listing step of listing loaded contents; an UI providing step of providing an UI tap on the list, the UI tap for allowing a user to select a loading criterion for additional content not included the list; and a loading step of loading the additional content based on the loading criterion selected by the user.

### TECHNICAL FIELD

Exemplary embodiments of the disclosure relate to a method and a system for loading additional content based on an order or a direction desired to be consumed by a user in a table view controller type application for listening contents.

### BACKGROUND

In general, Table View Controllers (hereinafter, “TVC”) are used a lot which express a list of contents after binding independent contents in each line of a table view type table, when listening contents on an application of a mobile terminal (e.g., a smart phone and a tablet PC). In other words, TVC means a controller used in loading contents having a repeated UI (User Interface) in an application (e.g., Twitter and Facebook) from a server. In a vast number of cases, an application using TVC provides aligned lists in accordance with a time order of independent content generation or a preset order provided from a server.

When using the contents provided from an application (e.g., Twitter and Facebook) through TVC, the user may read contents on a list from a top to a bottom or vice versa.

In such TVC environments, a screen size of a mobile terminal is limited. After contents are provided once, additional content is requested by the user and the list is updated. There are mainly two methods for requesting additional content.

In one method, in case the user request additional content after reading the contents provided on an application screen to the end, a direction of the user's request is recognized (upward or downward) and contents are read in the recognized direction. Referring to FIG. 1, a list of contents provided on an application screen 100 is made, using TVC. In this instance, the user scrolls the content list 101 and loading 102 of additional content is implemented at a top or bottom of the application screen 100. The application can recognize the user's content consumption direction clearly, only to recognize contents configured to be read and contents updated on TVC clearly. The user can recognize by which standard to call for contents from a corresponding application clearly.

In the other method, in case the user requests additional content in a state where contents are loaded after the application is implemented, it is determined which contents to be read based on a policy of the application and the determined contents are asked the server for. When loading the contents in TVC environments, there might be a period of information TVC fails to bind. In the other method, a loading button (for instance, left-out twit view button') 202 for loading additional content is provided between the content list 201 provided on the application screen 200 as shown in FIG. 2. However, such a conventional loading button 202 for making a request for additional content may not allow the application to designate the criterion. The criterion for loading the contents is vague and it is ambiguous whether additional content are loaded based on a criterion of (the time of) the contents located on the loading button 202 or (the time of) the contents located under the loading button 202. Also, it is difficult for the user to distinguish the loading criterion.

Accordingly, there are needs for techniques for calling for additional content in a direction the user desires conveniently in a current TVC structure.

### DISCLOSURE

### Technical Problem

Exemplary embodiments of the present disclosure provide a method and a system for loading contents which can request additional content in an order or a direction desired by a user, when a user uses a TVC (Table View Controller) application for listing contents.

### Technical Solution

To achieve these objects and other advantages and in accordance with the purpose of the invention, as embodied and broadly described herein, embodiments of the present disclosure provide a method for loading additional content including a listing step of listing loaded contents; an UI providing step of providing an UI tap on the list, the UI tap for allowing a user to select a loading criterion for additional content not included the list; and a loading step of loading the additional content based on the loading criterion selected by the user.

The listing step may provide a table view list having contents binding in each of lines provided a table, and when a period which the table view fails to bind in loading the contents is generated, the UI providing step may provide the UI tap in a position corresponding to the period.

The UI providing step may provide at least one UI tap between lines of the list.

The UI providing step may display guide information for a loading direction of the additional content on the UI tap.

The UI providing step may display guide information for at least one of a first direction in which the additional content are loaded with respect to contents corresponding to a line before the UI tap and a second direction in which the additional content are loaded with respect to contents corresponding to a line after the UI tap.

Embodiments of the present disclosure also provide a computer readable media comprising an instruction for a computer system to control loading of contents, the computer readable media for controlling the computer system based on a method, wherein the method including a listing step of listing loaded contents; an UI providing step of providing an UI tap on the list, the UI tap for allowing a user to select a loading criterion for additional content not included the list; and a loading step of loading the additional content based on the loading criterion selected by the user.

Embodiments of the present disclosure also provide a system for loading contents including a contents arranging unit for listing loaded contents; an UI providing unit for providing an UI tap on the list, the UI tap for allowing a user to select additional content not provided in the list; and a loading unit for loading the additional content based on a loading criterion selected by a user through the UI tap.

### Advantageous Effects

According to the embodiments of the present disclosure, when using the application for listing the contents in TVC type, the user can make a request for additional content in the desired order or direction for the period which fails to bind in TVC.

In an aspect of the application, unnecessary contents loading may be reduced and load of network traffic and server can be reduced advantageously.

According to the embodiment of the present disclosure, the guide information for the loading direction in the UI environments associated with the loading request for the additional content is displayed. Accordingly, in the user's aspect, the loading direction of the additional content may be recognized more intuitively.

### BRIEF DESCRIPTION OF THE DRAWINGS

FIGS. 1 and 2 are diagrams illustrating an exemplary screen to describe characteristics of an application using TVC;

FIG. 3 is a block diagram illustrating an inner configuration of a content loading system for loading additional content in a direction (or an order) desired by a user according to one exemplary embodiment of the present disclosure;

FIG. 4 is a schematic diagram illustrating a list of contents in the situation described in FIG. 2;

FIGS. 5 through 7 are schematic diagrams illustrating an application screen providing UI tap selectable in a loading direction of additional content; and

FIG. 8 is a flow chart illustrating a method for loading contents to load additional content in a direction (or an order) desired by the user.

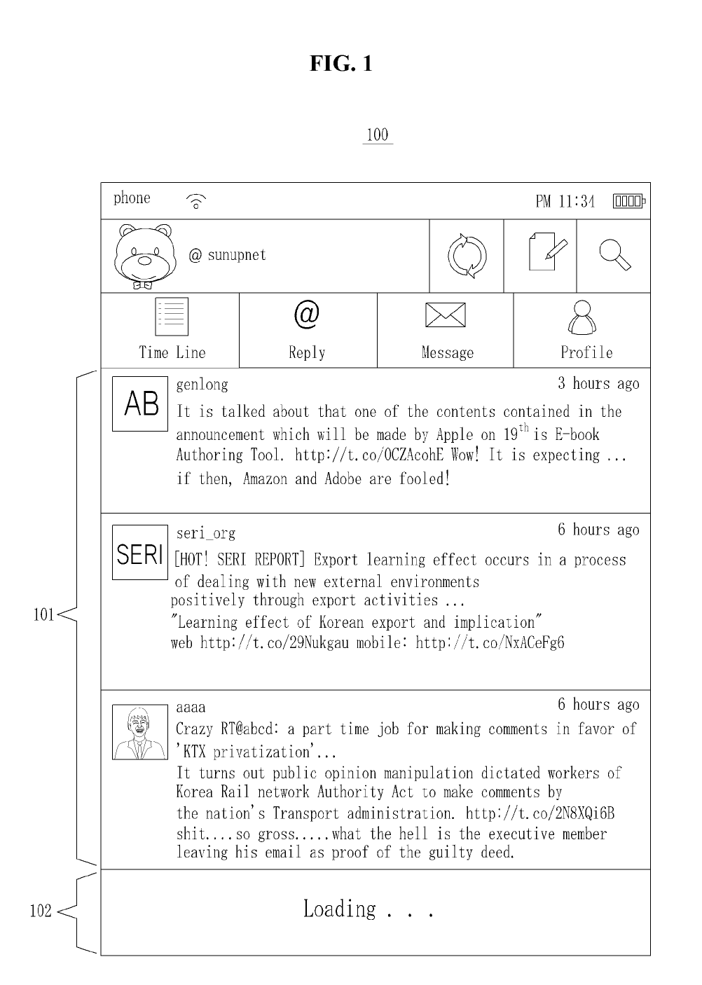

### DESCRIPTION OF DISCLSOURE

Hereinafter, exemplary embodiments of the disclosed subject matter are described more fully with reference to the accompanying drawings.

Embodiments of the present disclosure may be applied to an application which provides contents in an aligned list. For instance, TVC (Table View Controller) for binding contents located in each line and expressing a list of the contents may be used to list contents. In the embodiments of the present disclosure, an application may mean a program implemented by at least one processor provided in a mobile terminal (e.g., a smart phone and a tablet)

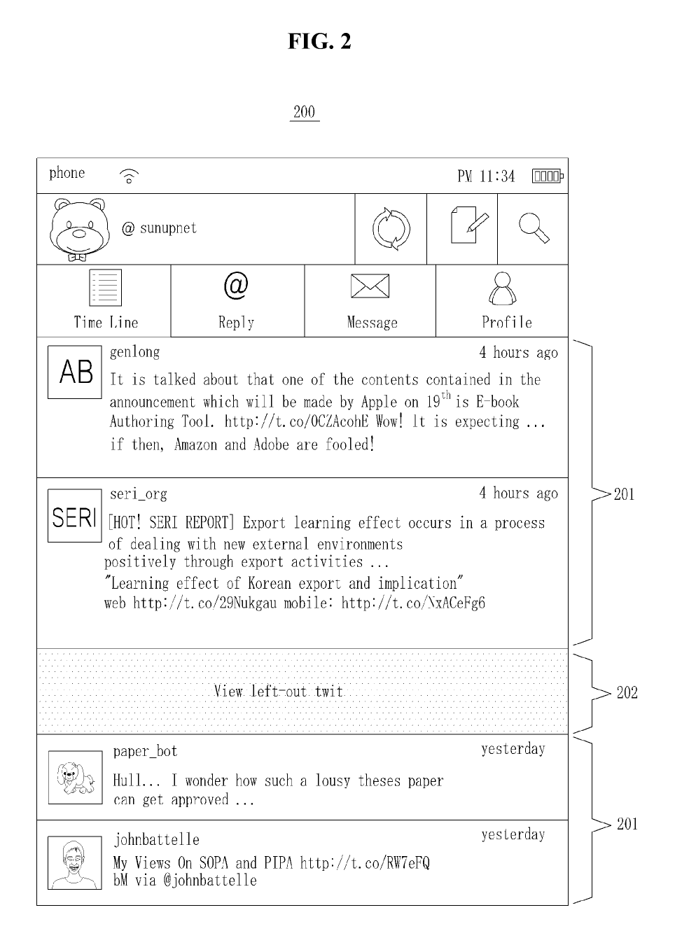

In one of the methods for loading contents as described with reference to FIG. 2, when a user makes a request for additional content in a state where contents are loaded by an implemented application, contents to be read are determined based on a policy of the application and the determined contents are asked a server for. In case of loading contents in TVC environments based on this method, there might be a period of information TVC fails to bind. For instance, when using Twitter again after a long time period when the process is not killed completely in a mobile terminal, in other words, in a state where an instance is alive in implemented Twitter in case of using Twitter application, a load event is applied to TVC and renewed contents are loaded. In case there is a large time difference between the contents loaded before and the contents loaded currently, there might be the situation shown in FIG. 2 (in other words, “left-out twit”).

Accordingly, embodiments of the present disclosure provide a method for loading contents out of the contents which TVC fails to bind based on a criterion desired by the user.

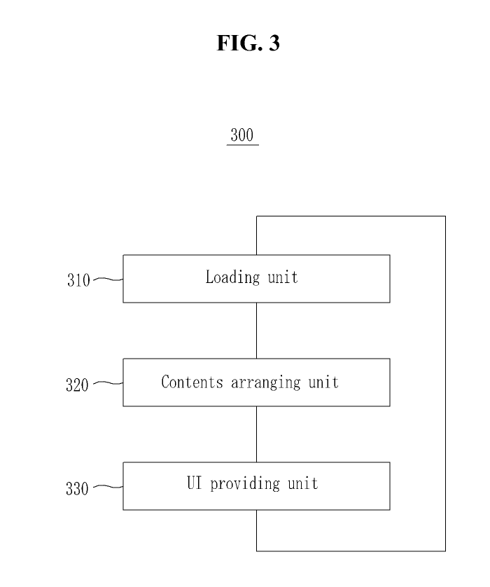

FIG. 3 is a block diagram illustrating an inner configuration of a content loading system for loading additional content in a direction (or an order) desired by a user according to one exemplary embodiment of the present disclosure. As shown in FIG. 3, a contents loading system 300 may include a loading unit 310, a contents-arranging unit 320 and a UI providing unit 330.

The loading unit 310 loads independent contents associated with a corresponding application in a preset period or in accordance with the user's request, in a state where the application is implemented. In addition, the loading unit 310 may load contents in a criterion (a direction or an order) desired by the user additionally. When loading the additional content, a method for recognizing the criterion the user desires will be described later.

The contents arranging unit 320 may list the loaded contents, using TVC. In the application using TVC, the application is implemented and a load event is generated in TVC such that arranged lists of loaded contents can be provided together with the loading of the contents. Accordingly, the user may consume separate contents listed on the list provided on an execution screen of the application.

The UI providing unit 330 may provide an UI tap on the list and the UI tap which allows a loading criterion for additional content, not provided in the current list on the execution careen of the application, to be selectable.

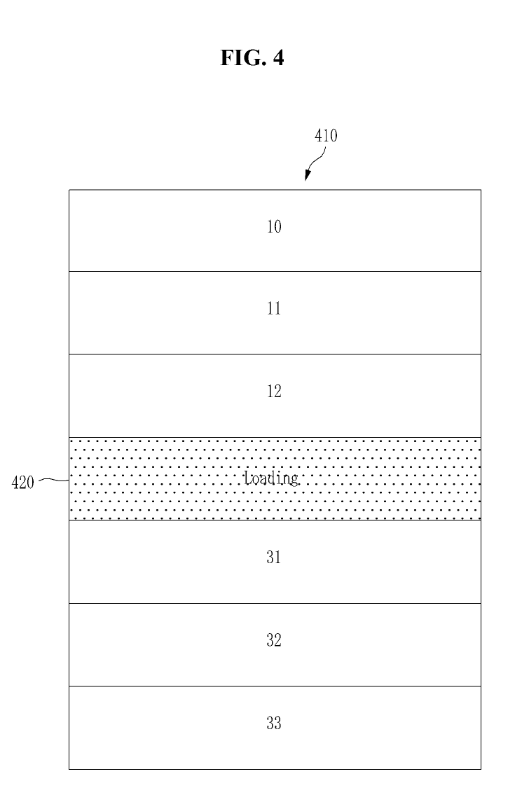

FIG. 4 is a schematic diagram illustrating a list of contents in the situation described in FIG. 2. Referring to FIG. 4, there are contents left out between 12 contents and 31 contents on a corresponding list 410 while listing independent contents 10, 11, 12, 31, 32 and 33 through TVC once the application is implemented. In this condition, a loading UI is activated for the left-out content period simply in the prior art and the user clicks the loading UI 420 to load the left-out contents based on the policy of the corresponding application. After that, the list 410 is renewed. However, in case the user clicks the loading UI 420 in the condition mentioned above with reference to FIG. 4, the user's expectation may be diverse. For instance, the user desires to load next contents (e.g., contents after 13) with respect to 12 contents or former contents (e.g., contents before 30) with respect to 31 contents.

The UI providing unit 330 may provide the UI tap on the corresponding list and the UI tap allows the user to directly select a loading criterion for additional content. At this time, the UI providing unit 330 may provide at least one UI tap between lines of the list of the separate contents. Especially, the UI providing unit 330 may provide an UI tap in a position corresponding to a period having an information period fails to bind (in other words, the left-out contents period).

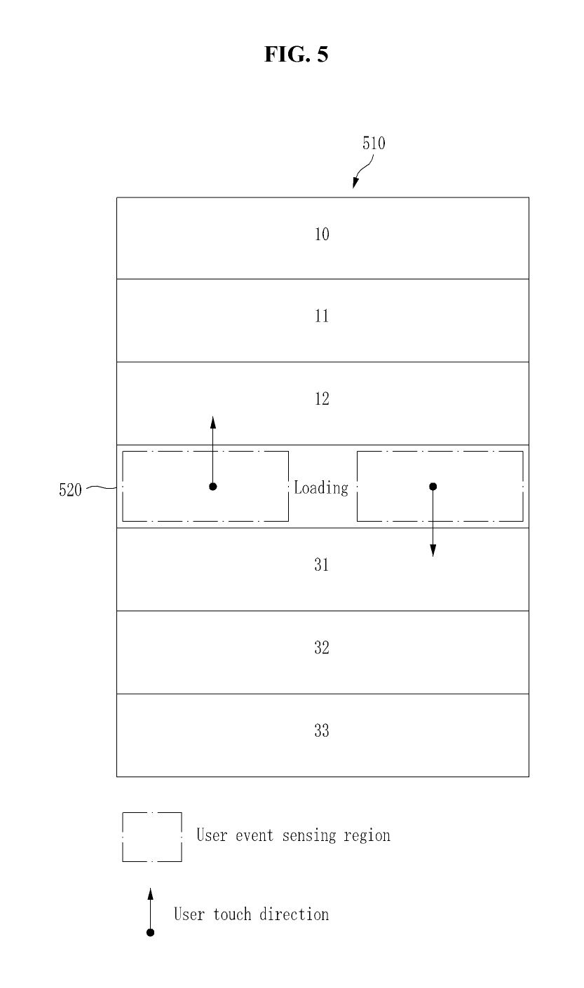

FIG. 5 illustrates one embodiment of the UI tap which allows a loading direction of the additional content selectable. As shown in FIG. 5, the UI providing unit 330 may provide a UI tap in a left-out contents period of a list 510. At this time, a message of ‘loading’ may be displayed on the UI tap 520 and at least one event sensing region for sensing a touch-based input event from the user may be set on the UI tap 520. For instance, as shown in FIG. 5, event sensing regions may be set right and left with respect to the loading message. One of the event sensing regions is set in a direction for loading the left-out contents with respect to corresponding contents corresponding to a line before the UI tap 520 (a first direction) and the other one is set in a direction for loading the left-out contents with respect to the contents corresponding to a line right after the UI tap 520 (a second direction). For instance, when the user touches the left even sensing region or flicks the corresponding event sensing region upward, contents after 12 contents (13 and the next ones) may be loaded. In contrast, when the user touches the right event sensing region or flicks it downward, former contents with respect to 31 contents (contents before 30) may be loaded. The UI providing unit 330 may display guide information for the loading direction of the additional content on the event sensing region, when providing the UI tap 520 allowing the user to recognize the loading direction of the additional content.

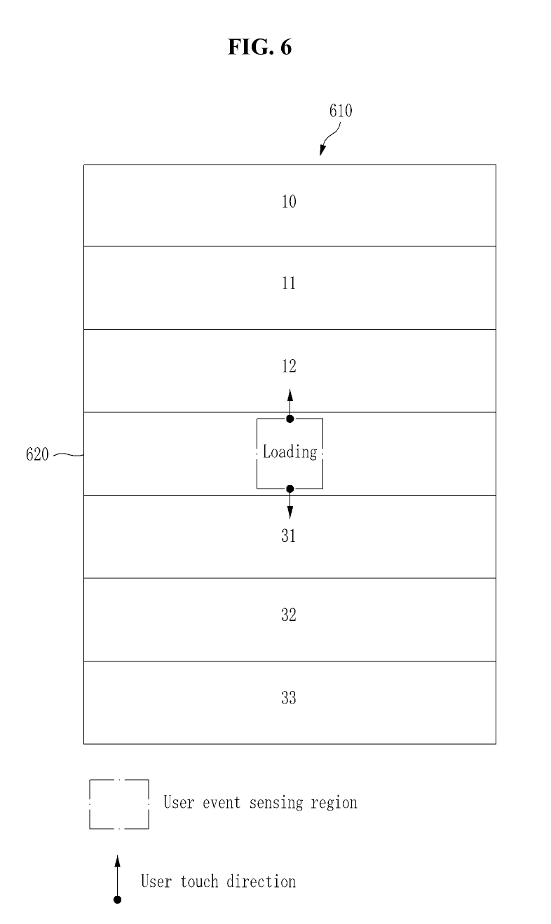

FIG. 6 illustrates another embodiment of the UI tap allowing the loading direction of the additional content selectable. As shown in FIG. 6, the UI providing unit 330 provides an UI tap 620 in left-out contents of a list 610. At this time, a region having a message of ‘loading’ may be set as a touch-based input event sensing region. For instance, when the user flicks the loading message upward on the UI tap 620, next contents with respect to 12 contents (contents after 13) may be loaded. In contrast, when the user flocks the loading message downward, former contents with respect to 31 contents (contents before 30) may be loaded. The UI providing unit 330 may recognize the user's movement (a touch direction) downward or upward, while the user is touching the loading message, to display a loading direction selected by the user. In case guide information for the loading direction of the additional content is not displayed on the UI tap 620, the user may recognize a loading direction of the additional content in the UI tap 520 through learning.

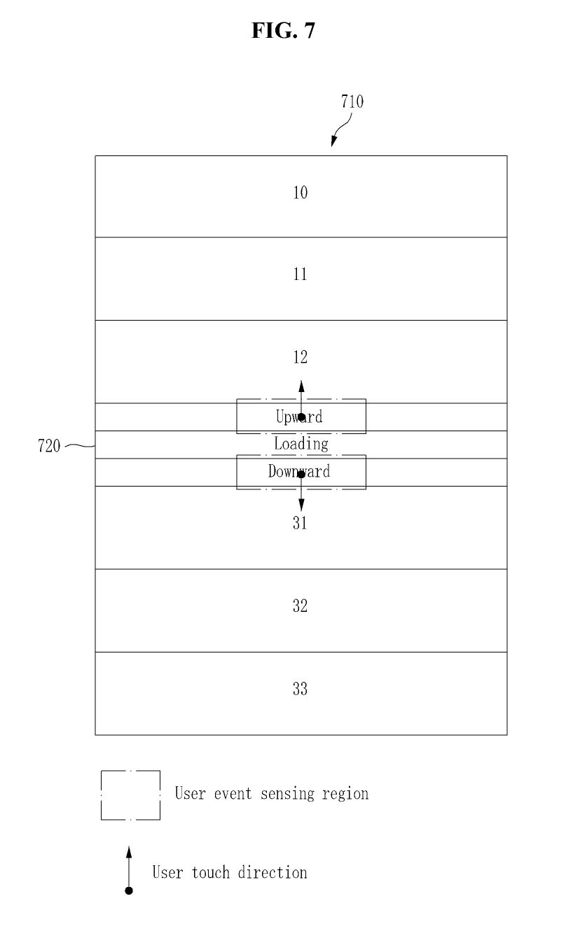

FIG. 7 illustrates a further embodiment of the UI tap allowing the loading direction of the additional content selectable. As shown in FIG. 7, the UI providing unit 330 provides an UI tap 720 in left-out contents of a list 710. At this time, the UI tap 720 may include a tap displaying a message of ‘loading’, a tap for loading in a first direction (a direction for loading left-out contents with respect to contents corresponding to a line before the UI tap 720), and a tap for loading in a second direction (a direction for loading left-out contents with respect to contents corresponding to a line after the UI tap 720). An event sensing region may be set in a predetermined area of the tap in the first direction and the tap in the second direction. A message for describing a loading direction may be displayed on the corresponding region. When the user touches the tap in the first direction or flicks the tap upward, the next contents with respect to 12 contents (contents after 13) may be loaded. In contrast, when the user touches the tap in the second direction or flicks the tap downward, former contents with respect to 31 contents (contents before 30) may be loaded. In case of providing the tap for each loading direction on the UI tap 720, the user can understand the function of the UI tap 720 more intuitively than only the message displayed on the tap without learning.

With the configuration mentioned above, the contents loading system 300 may recognize the loading criterion (the direction or order) selected by the user through the UI tap, such that the user may load the additional content based on the selected criterion only to renew the corresponding list.

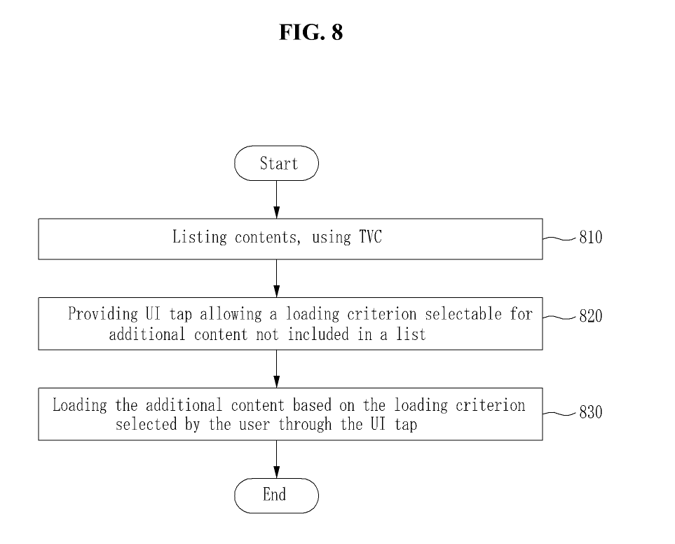

FIG. 8 is a flow chart illustrating a method for loading contents to load additional content in a direction (or an order) desired by the user. In the method for loading the contents according to one embodiment of the present disclosure, each of steps may be performed by the contents loading system mentioned above with reference to FIG. 3.

In a step 810, the contents loading system may list the loaded contents, using TVC. When implementing the application using TVC, a load event is generated in TVC and the arranged lists of the loaded contents may be provided together with the loading of the contents.

In a step 820, the contents loading system may provide the UI tap on the corresponding list and the UI tap allows the user to select a loading criterion for additional content. Loading contents in TVC environments, an information period which TVC fails to bind may be generated. In this instance, the contents loading system may provide the UI tap allowing the user to directly select the loading criterion for contents of the corresponding period on the list. At this time, the contents loading system may provide at least one UI tap between lines provided in the list of the separate contents. In addition, in case the information period which TVC fails to bind (in other words, a left-out contents period) is generated, the contents loading system may provide the UI tap in a position corresponding to the left-out contents period out of lines provided in the list. The contents loading system may display guide information for the loading direction of the additional content on the UI tap, when providing the UI tap for the user to recognize the loading direction of the additional content easily. At this time, the contents loading system may display the guide information on at least one of the first loading direction for loading the additional content with respect to contents corresponding to the line right before the UI tap and the second direction for loading the additional content with respect to contents corresponding to the line right after the UI tap on the UI tap provided between lines of the list of the separate contents. Accordingly, the user may touch the UI tap corresponding to the desired loading direction or flick the UI tap in the desired direction, only to select the loading direction for the additional content.

In a step 830, the contents loading system recognizes the loading criterion selected by the user through the UI tap and loads corresponding additional content based on the criterion, only to renew the corresponding list.

According to the embodiments of the present disclosure, when using the application for listing the contents in TVC type, the user can make a request for additional content in the desired order or direction for the period which TVC fails to bind. In an aspect of the application, unnecessary contents loading may be reduced and load of network traffic and server can be reduced advantageously. According to the embodiment of the present disclosure, the guide information for the loading direction in the UI environments associated with the loading request for the additional content is displayed. Accordingly, in the user's aspect, the loading direction of the additional content may be recognized more intuitively.

The method and system for loading the contents may include applications exclusively for a terminal (e.g. smart phone applications and feature phone VM (virtual machine)) which can be implemented in all types of terminals including PCs, smart phones and tablets. They may be implemented by at least one processor driven in a terminal.

The methods mentioned hereinabove may be realized as program commands implemented through various computing means and recorded in a computer readable media. The computer readable media may include a program command, a data file, a data structure or combination of them. The program command recorded in the medium may be configured for exemplary embodiments of the disclosure. Examples of computer readable medium include magnetic medium such as a hard disk, a floppy disk, optical medium such as CD-ROM and DVD, magneto-optical medium such as a floptical disk, and a hardware device such as ROM, RAM, and a flash memory. The hardware device may be configured to execute one or more software modules to implement the exemplary embodiments. Examples of the program commands may include a mechanical language code made by a compiler and a high level language code implementable by a computer, using an interpreter, and the like. The hardware device may be configured to execute one or more software modules to implement the exemplary embodiments.

Various variations and modifications of the refrigerator described above are possible in the component parts and/or arrangements of the subject combination arrangement within the scope of the disclosure, the drawings and the appended claims.

In addition to variations and modifications in the component parts and/or arrangements, alternative uses will also be apparent to those skilled in the art.

What is claimed is:

1. A method for loading additional content comprising:
a listing step of listing loaded contents;
an UI providing step of providing an UI tap on the list, the UI tap for allowing a user to select a loading criterion for additional content not included the list; and
a loading step of loading the additional content based on the loading criterion selected by the user.

2. The method for loading the additional content of claim 1, wherein the listing step provides a table view list having contents binding in each of lines provided a table, and
when a period which the table view fails to bind in loading the contents is generated, the UI providing step provides the UI tap in a position corresponding to the period.

3. The method for loading the additional content of claim 1, wherein the UI providing step provides at least one UI tap between lines of the list.

4. The method for loading the additional content of claim 1, wherein the UI providing step displays guide information for a loading direction of the additional content on the UI tap.

5. The method for loading the additional content of claim 3, wherein the UI providing step displays guide information for at least one of a first direction in which the additional content are loaded with respect to contents corresponding to a line before the UI tap and a second direction in which the additional content are loaded with respect to contents corresponding to a line after the UI tap.

6. A computer readable media comprising an instruction for a computer system to control loading of contents, the computer readable media for controlling the computer system based on a method, wherein the method comprises,
a listing step of listing loaded contents;
an UI providing step of providing an UI tap on the list, the UI tap for allowing a user to select a loading criterion for additional content not included the list; and
a loading step of loading the additional content based on the loading criterion selected by the user.

7. A system for loading contents comprising:
a contents arranging unit for listing loaded contents;
an UI providing unit for providing an UI tap on the list, the UI tap for allowing a user to select additional content not provided in the list; and
a loading unit for loading the additional content based on a loading criterion selected by a user through the UI tap.

8. The system for loading the contents of claim 7, wherein the contents arranging unit provides a list provides a table view list having contents binding in each of lines provided a table, and
when a period which the table view fails to bind in loading the contents is generated, the UI providing unit provides the UI tap in a position corresponding to the period.

9. The system for loading the contents of claim 7, wherein the UI providing unit provides at least one UI tap between lines of the list.

10. The system for loading the contents of claim 7, wherein the UI providing unit displays guide information for a loading direction of the additional content on the UI tap.

11. The system for loading the contents of claim 9, wherein the UI providing unit displays guide information for at least one of a first direction in which the additional content are loaded with respect to contents corresponding to a line before the UI tap and a second direction in which the additional content are loaded with respect to contents corresponding to a line after the UI tap.
